(19) United States
(12) Patent Application Publication
(10) Pub. No.: US 2018/0277331 A1
(43) Pub. Date: Sep. 27, 2018

(54) RECEPTACLE FOR RECEIVING A PLUG CONNECTOR OF A HIGH-VOLTAGE CABLE FOR A MICROFOCUS X-RAY TUBE, PLUG CONNECTION FOR A HIGH-VOLTAGE CABLE

(71) Applicant: YXLON INTERNATIONAL GMBH, Hamburg (DE)

(72) Inventors: Lothar Schultheis, Oftringen (CH); Bjoern Schrader, Hamburg (DE)

(21) Appl. No.: 15/921,774

(22) Filed: Mar. 15, 2018

(30) Foreign Application Priority Data
Mar. 15, 2017 (DE) 102017105546.0

(51) Int. Cl. H01J 35/16; H01J 35/22; H01J 35/06; H01J 35/14; H01J 35/04

(52) U.S. Cl. CPC H01J 35/165; H01J 35/22; H01J 35/045; H01J 35/14; H01J 35/06

(57) ABSTRACT

A receptacle for receiving a plug connector of a high-voltage cable for a microfocus X-ray tube with a cathode, which has a metal filament and grid. The receptacle has a ceramic insulator with three contiguous cavities. The first cavity near the filament includes electrical contacts for the filament and the grid. The second cavity includes spring contacts for supplying current to the filament and a center pin for supplying voltage to the grid. The third cavity receives the plug connector. The insulator has a removable grid cap which is conductively connected to the grid of the cathode. The first and second cavities are surrounded in the radial direction by the grid cap, An air gap extends radially between grid cap and ceramic body. At the end of the grid cap remote from the filament is a circumferential groove in the axial direction between the grid cap and the ceramic insulator.

### CROSS-REFERENCE TO RELATED APPLICATIONS

This application is related to and claims priority under 35 U.S.C. § 119(a) to German patent application No. 102017105546.0, filed Mar. 15, 2017, the contents of which are incorporated by reference herein in its entirety.

### FIELD OF THE INVENTION

The invention relates to a receptacle for receiving a plug connector of a high-voltage cable for a microfocus X-ray tube with a cathode, which has a filament and a grid cap made of metal, as well as to a plug connection for a high-voltage cable for a microfocus X-ray tube, which has a plug connector and such a receptacle.

### BACKGROUND OF THE INVENTION

The transmission of high voltage from the outside of an open microfocus X-ray tube to the inside—the cathode chamber—of this X-ray tube under high vacuum can lead to voltage flashovers, The operation of such X-ray tubes is badly disrupted by such voltage flashovers. By microfocus X-ray tubes is meant X-ray tubes which have a focal spot (focus) in the μm range. In contrast, “normal” X-ray tubes have an effective size in the mm range.

For certain applications, it is advantageous if the X-ray tube is operated with a high voltage. For this, for the transmission of the high voltage and of the electrical current, a receptacle made of an epoxy resin as insulator has been used, for example in the case of the applicant's FXE-225 model. Through the encapsulation of the electrical connection with epoxy resin, voltage flashovers due to high field strengths are to be prevented. One problem here is, however, that epoxy plastics emit gas and thus impair the vacuum. The use of ceramic materials for the receptacle could alleviate this problem—as has already been done hitherto in the case of closed X-ray tubes—however, the problem arises here that high field strengths develop in the contact area between the plug connector and the receptacle and voltage flashovers caused thereby occur, which are precisely to be prevented. Unlike with the use of epoxy resins, it is not possible with ceramics to encapsulate the electrical contacts in order to guarantee sufficient dielectric strength.

### SUMMARY OF THE INVENTION

An object of the invention is to provide a receptacle and a plug connection for a high-voltage cable for a microfocus X-ray tube, in which no voltage flashovers occur even at high voltages.

The object is achieved by a plug connector with the features of claim 1. In order to prevent voltage flashovers at high voltages in the plug connection, the receptacle according to the invention is equipped with a combination of three features. Firstly, the use of spring contacts for the transmission of the filament current from the high-voltage cable via the high-voltage plug connector to the filament; narrow gaps and thus high field strengths are thereby prevented. Secondly, the use of an extended grid cap of the cathode; shielding of the field in the area of the plug connection is thereby achieved, which reduces the field strength there. Thirdly, the use of internal metallization of the insulator in the area of the current and voltage transmission when the high-voltage plug connector of the high-voltage cable is inserted (thus, in the second cavity of the ceramic insulator); the field strength is also reduced by this. As a result of the above-named three cumulative measures according to the invention an enormous reduction in the field strengths developing in the area of the plug connection is achieved, with the result that high voltages can be applied to the microfocus X-ray tube with a small constructed size without voltage flashovers being produced. As a result of the described features according to the invention, ceramic material can thus be used in spite of the problems described above, which have until now deterred a person skilled in the art from using ceramic for microfocus X-ray tubes having a small constructed size, since these measures lead to the described drastic reduction in the field strength at the relevant points.

An advantageous development of the invention provides that the second cavity is formed cylindrical over the bulk of its axial length.

A further advantageous development of the invention provides that the third cavity is formed frustoconical over the bulk of its axial length. High-voltage cables with high-voltage plug connectors known from the state of the art, which have a corresponding shape, can thereby still be used and a surface contact forms all over without air pockets.

The object is also achieved by a plug connection with the features of claim 4. The advantages stated there result hereby analogously for the reasons already named above in relation to claim 1.

An advantageous development of the invention provides that the second area of the high-voltage plug connector has a rubber cone and/or the second area of the high-voltage plug connector is frustoconical. By means of the rubber coating in the form of the rubber cone over an HV flange the high-voltage plug connector can be pushed into the receptacle under pressure to fit precisely, with the result that there is a surface contact between receptacle and high-voltage plug connector over the whole surface and no gaps form between high-voltage plug connector and receptacle (or the ceramic insulator thereof); gaps would increase the risk of voltage flashovers, The use of frustoconical high-voltage plug connectors has the advantage that common high-voltage plug connectors can be used since these have such a shape.

The object is also achieved by the use of a receptacle according to the invention and/or of a plug connection according to the invention with the features of claim 6. The applied high voltage is at least 160 kV, preferably at least 250 kV and particularly preferably at least 320 kV. The microfocus X-ray tube can thus accommodate very high voltages with a small constructed size of the plug connection—which also makes possible a small constructed size for the whole microfocus X-ray tube—which leads to a widening of the range of application of such X-ray tubes.

All of the features of the advantageous developments indicated in the dependent claims form part of the invention both individually per se in each case and also in any desired combinations.

### BRIEF DESCRIPTION OF THE DRAWINGS

FIG. 1 depicts a partial section through a cathode of a microfocus X-ray tube with a receptacle according to the invention;

FIG. 2 depicts an enlargement of the contact area of FIG. 1 in full section without filament module; and

FIG. 3 depicts a scaled-down isometric view of a high-voltage plug connector of a high-voltage cable.

### DETAILED DESCRIPTION OF THE INVENTION

In the following, an advantageous embodiment example of a receptacle according to the invention is explained in the context of its connection to a cathode of an open microfocus X-ray tube.

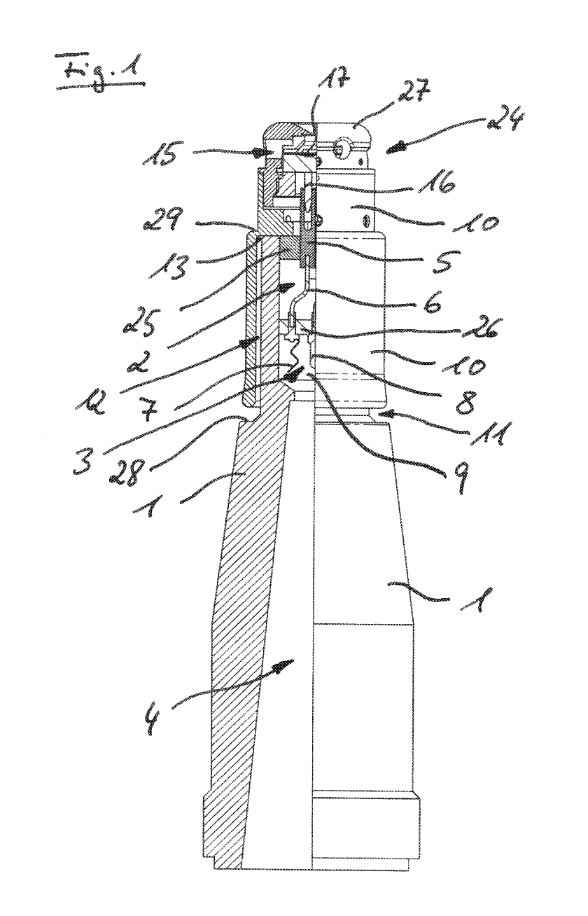

In FIG. 1, an embodiment example of a receptacle according to the invention with grid cap 10 and fitted grid unit 15 of a cathode 24 of the microfocus X-ray tube is represented in a partial section. Here, the left half of the representation is in section and the right half is represented as a view. The boundary of the two representations coincides with the central longitudinal axis of the receptacle.

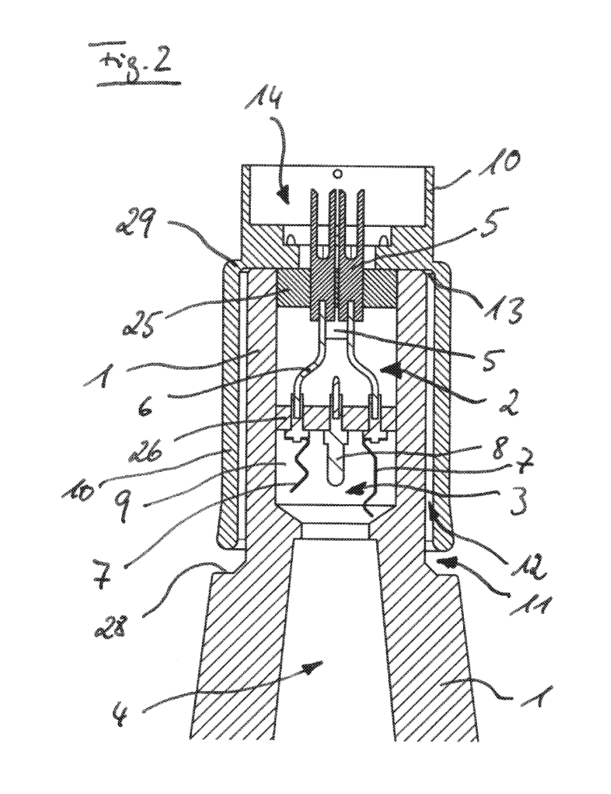

In the following, the embodiment example of FIG. 1 is described together with FIG. 2. In FIG. 2, an enlarged sectional representation of the upper area of the receptacle of FIG. 1 is represented without the grid unit 15. In this figure, some details can be identified better than in FIG. 1.

The receptacle according to the invention has, as base body, a ceramic insulator 1, which consists of a ceramic material. In the represented embodiment example, this ceramic material is Al₂O₃. The ceramic insulator 1 essentially has three sections.

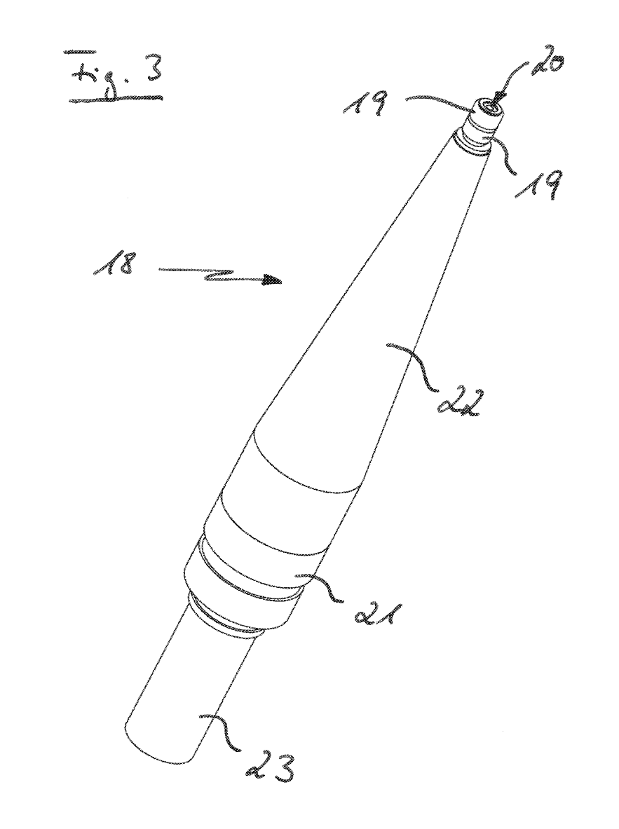

A first cavity 2 is formed in its, in FIGS. 1 and 2, upper section, which is connected to the grid unit 15 in an electrically conducting manner. This first cavity 2 is designed cylindrical. Inside the cavity, two electrical contacts 5 are arranged, which serve to transmit the filament current (in a range from 5-6 A in the embodiment example), which is supplied via a high-voltage cable 23 (see FIG. 3), via electrical conductors (wires) 6, which are also arranged inside the first cavity 2 and are assigned to the electrical contacts 5, to a filament 17 in the grid unit 15. The electrical contacts 5 at the upper end of the first cavity 2 and the electrical conductors 6 at the lower end of the first cavity 2 are each held in a plate (at the top of a closing plate 25 and at the bottom of a contact plate 26) made of an insulating material—in the present embodiment example made of Al₂O₃—which are firmly soldered to the ceramic insulator 1. In addition, a third electrical contact 5 is also present, which brings the high voltage (225 kV in the embodiment example) from the high-voltage cable 23 into a grid 27 (focusing cup) of the cathode 24. Otherwise, there is no further material present in the first cavity 2.

A second cavity 3 follows the end of the contact plate 26 facing away from the grid unit 15. It is also formed cylindrical with the same diameter as the first cavity 2. At its lower end, facing away from the grid unit 15, it has a short part (in relation to the axial direction seen in comparison with the cylindrical part), which tapers towards the bottom. The surface of the second cavity 3 is provided with a metal layer 9 (here made of an alloy of molybdenum, manganese and nickel). The metal layer 9 was deposited on the inner surface of the ceramic insulator 1 by means of methods known to a person skilled in the art. Two spring contacts 7, which are in contact through the contact plate 26 with the two electrical conductors 6 which transport the filament current, project into the second cavity 3 from the contact plate 26. A third electrical conductor 6 in the first cavity 2 which conducts the high voltage is in contact through the contact plate 26 with an electrically conducting centre pin 8, which likewise extends into the second cavity 3 along the central longitudinal axis of the ceramic insulator 1. In the assembled state of the high-voltage plug connector 18 of the high-voltage cable 23, the second cavity 3 serves to make the electrical contact between high-voltage cable 23 and filament 17 or grid 27.

Towards the bottom, a third cavity 4 follows the conical part of the second cavity 3, which third cavity 4—except for a cylindrical part that is very short in relation to the axial direction—widens conically towards the bottom and forms a frustoconical part. This frustoconical part serves to receive a rubber cone 22 of the high-voltage plug connector 18 (see FIG. 3) in the assembled state of the high-voltage plug connector 18 in the receptacle of FIGS. 1 and 2.

Hitherto, only the internal shape of the ceramic insulator 1 has been described with reference to its three cavities 2, 3, 4, The description of the outer surface of the ceramic insulator 1 now follows.

In the area of the first and second cavities 2, 3, the outer surface of the ceramic insulator 1 is formed cylindrical. The cylindrical shape extends into the upper area of the third cavity 4. There, the ceramic insulator 1 widens via a circumferential projection 28 and transitions into an area widening conically towards the bottom. Another cylindrical area is then finally connected thereto.

At the upper end of the ceramic insulator 1, a metallic grid cap 10 is firmly connected to the ceramic insulator 1. The grid cap 10 is formed axially symmetrical about the central longitudinal axis of the ceramic insulator 1 and centrally has a through hole, through which the electrical contacts 5 pass without a conductive connection. At the upper end, the grid cap 10 is formed cup-shaped with the result that a receiving recess, the grid receptacle 14 (see FIG. 2), is available for the insertion of the grid unit 15 into the grid cap 10. In the installed state of the grid unit 15 in the grid receptacle 14, the grid 27 is conductively connected to the grid cap 10. The filament current is conducted to the filament 17 through filament contact pins 16 on the grid unit 15, which engage in the electrical contacts 5, The grid 27 is supplied with high voltage from the high-voltage cable 23 via a corresponding electrical connection, known to a person skilled in the art, to the electrical contact 5 available for this.

In the area of the first and second cavities 2, 3 of the ceramic insulator 1—the lower area of the grid cap 10—the grid cap 10 is substantially in the shape of a cylinder barrel and is connected in one piece to the previously-described upper area of the grid cap 10 via a shoulder 29. At the lower end, the outer surface of the grid cap 10 widens slightly, Between the inner surface of the lower area of the grid cap 10 and the outer surface of the ceramic insulator 1, a substantially constant cylindrical air gap 12 is formed. In the area of the shoulder 29, just described, of the grid cap 10, a triple point 13 is formed (this is actually a ring, which extends concentrically about the central longitudinal axis of the ceramic insulator 1), at which three different media meet: metal of the grid cap 10, ceramic of the ceramic insulator 1 and air/vacuum of the air gap 12. Between the lower end of the grid cap 10 and the projection 28 of the ceramic insulator 1, there is a space in the axial direction which leads to a circumferential groove 11,

In FIG. 3, a high-voltage plug connector 18 with high-voltage cable 23 (not to scale with FIGS. 1 and 2) attached thereto is represented. In its upper end area remote from the cable, the high-voltage plug connector 18 has two ring contacts 19 that are electrically insulated from each other, which, in the assembled state of the high-voltage plug connector 18 inside the receptacle according to the invention, supply the filament 17 with the filament current via the two spring contacts 7. At the tip, electrically insulated from the two ring contacts 19, a centre contact 20 in the form of a bush is formed, in which, in the assembled state of the high-voltage plug connector 18 inside the receptacle according to the invention, the centre pin 8 engages and supplies the grid 27 of the cathode 24 with high voltage via this electrical connection. The cabling inside the high-voltage cable 23 and the high-voltage plug connector 18 is known to a person skilled in the art from the state of the art, The high-voltage plug connector 18 is pushed into the third cavity such that the rubber cone 22 is pressed in a form-fitting manner into the third cavity 4. The rubber cone 22 is mounted on a fixed threaded part 21 of an HV flange, which is made from stainless steel. The surface contact between the wall of the third cavity 4 of the receptacle and the surface of the rubber cone 22 is produced by screwing the threaded part 21 of the HV flange on a component part of the microfocus X-ray tube, which is arranged fixed in position relative to the ceramic insulator 1, by means of 4 screws (which are not represented).

Through the design according to the invention of the receptacle, the field strengths developing in operation—when the high-voltage plug connector 18 is assembled—can be very greatly reduced with the result that, in spite of the use of ceramic instead of epoxy resin for the ceramic insulator 1, the risk of voltage flashovers is negligible, even when high voltages of 320 kV are applied. Even at the most problematic spring contacts 7, field strengths of less than 6 kV/mm are achieved at a voltage of 225 kV. This is achieved by the combination according to the invention of spring contacts 19 on the receptacle in conjunction with ring contacts 7 on the high-voltage plug connector 18, a very long grid cap 10 and the internal metallization of the second cavity 3 of the ceramic insulator 1 by means of the metal layer 9.

### LIST OF REFERENCE NUMBERS

1 ceramic insulator
2 first cavity
3 second cavity
4 third cavity
5 electrical contact
6 electrical conductor (wire)
7 spring contact
8 centre pin
9 metal layer
10 grid cap
11 circumferential groove
12 air gap
13 triple point
14 grid receptacle
15 grid unit
16 filament contact pin
17 filament
18 high-voltage plug connector
19 ring contact
20 centre contact
21 threaded part for HV flange
22 rubber cone
23 high-voltage cable
24 cathode
25 closing plate
26 contact plate
27 grid (focusing cup)
28 projection
29 shoulder

1. A receptacle for receiving a high-voltage plug connector (18) of a high-voltage cable (23) for a microfocus X-ray tube with a cathode (24), which has a filament (17) and a grid (27) made of metal,
wherein the receptacle has a ceramic insulator (1) as insulator,
wherein the ceramic insulator (1) has a first cavity (2), which is formed at its end near the filament and is crossed by electrical contacts (5) for the filament and the grid (27) as well as electrical conductors (6),
wherein the ceramic insulator (1) has a second cavity (3), which follows the first cavity (2) at its end remote from the filament, in which spring contacts (7) for supplying current to the filament (17) and a centre pin (8) for supplying voltage to the grid (27) are available for connection to the high-voltage plug connector (18) and the surface of which is covered by a metal layer (9),
wherein the ceramic insulator (1) has a third cavity (4), which follows the second cavity (3) at its end remote from the filament, and which has a shape to guarantee an accurate fit of the high-voltage plug connector (18) in the inserted state,
wherein the ceramic insulator (1) has a grid cap (10), which, in the installed state, is conductively connected to the grid (27) of the cathode (24), and the first cavity (2) and the second cavity (3) are surrounded in the radial direction by the grid cap (10), wherein, between grid cap (10) and ceramic body (1), an air gap (12) is formed in the radial direction,
wherein, at the end of the grid cap (10) remote from the filament, there is a circumferential groove (11) in the axial direction between the grid cap (10) and the ceramic insulator (1).

2. The receptacle according to claim 1, wherein the second cavity (3) is formed cylindrical over the bulk of its axial length.

3. The receptacle according to claim 1, wherein the third cavity (4) is formed frustoconical over the bulk of its axial length.

4. A plug connection for a high-voltage cable (23) for a microfocus X-ray tube with a receptacle according to claim 1 and a high-voltage plug connector (18) which, at its end, has a first area, in which ring contacts (19) are present, and has a second area following thereon, which has a shape which, in the assembled state, contacts in form-fitting manner the third cavity (4) of the ceramic insulator (1) of the receptacle, wherein the first area of the high-voltage plug connector (18), in the assembled state, is arranged in the second cavity (3) of the ceramic insulator (1) of the receptacle.

5. The plug connection according to claim 4, wherein the second area of the high-voltage plug connector (18) has a rubber cone (22) and/or the second area of the high-voltage plug connector (18) is frustoconical.

6. A use of a receptacle and/or of a plug connection according to claim 1, wherein the applied high voltage is at least 160 kV, preferably at least 250 kV and particularly preferably at least 320 kV.
